(19) United States
(12) Patent Application Publication
(10) Pub. No.: US 2004/0249791 A1
(43) Pub. Date: Dec. 9, 2004

(54) Method and system for developing and querying a sequence driven contextual knowledge base

(76) Inventors: Michael D. Waters, Chapel Hill, NC (US); James K. Selkirk, Chapel Hill, NC (US); Raymond W. Tennant, Raleigh, NC (US)

Correspondence Address: LEYDIG VOIT & MAYER, LTD, 700 THIRTEENTH ST. NW, SUITE 300, WASHINGTON, DC, 20005-3960, US

(21) Appl. No.: 10/452,384

(22) Filed: Jun. 3, 2003

(51) Int. Cl. G06F 7/00

(52) U.S. Cl. 707/3

(57) ABSTRACT

Disclosed is a method and system of predictive toxicology in the form of a multigenome knowledge base incorporating gene and protein molecular expression analysis, gene/protein functional annotation, domain specific ontologies, and literature mapping. The knowledge base can be globally queried by means of local sequence alignment as well as by any other knowledge base object. This sequence linkage enables continuous refinement of data quality, information documentation, and integration of new knowledge across species. Any molecular expression profile derived experimentally or in the clinic, representing expressed genes, proteins, or partial sequences known to the knowledge base, can be used to globally query the knowledge base to find common concordant expression profiles reflecting specific clinical observations and measurements that have been indexed and context documented in terms of dose, treatment time and phenotypic severity.

### FIELD OF THE INVENTION

This invention pertains to a bioinformatics knowledge base.

### BACKGROUND OF THE INVENTION

Recent biological research efforts have amassed staggering amounts of biological information related to most every aspect of biological study including genomics, proteomics, structural biology, clinical chemistry, and the like. Despite the generation of great repositories of biological data, researchers continue to struggle in creating means to meaningfully analyze and retrieve biological information. In response to the overwhelming need for tools for biological information management, those of skill in the art have adapted traditional computer-driven data management systems to create bioinformatics tools. Bioinformatics has been defined by the BISTIC Committee of the National Institutes of Health (Jul. 17, 2000) as “research, development, or application of computational tools and approaches for expanding the use of biological, medical, behavioral or health data, including those to acquire, store, organize, archive, analyze, or visualize such data.”

Many bioinformatics tools are available for managing and querying biological information. For example, GenBank, available over the internet by the National Center for Biotechnology Information (http://www.ncbi.nlm.nih.gov), allows identification of nucleotide sequences by sequence alignment (BLAST) and search of key words. Such bioinformatics tools are useful in determining primary connections between genes based on nucleotide sequence alignment. Yet, more sophisticated tools are required for scientific analysis that is multidisciplinary, such as toxicogenomics.

Toxicogenomics combines the traditional study of genetics and toxicology to elucidate the effects of toxicants on the molecular expression profile of an organism. Toxicogenomic profiles include information regarding nucleotide sequences, gene expression levels, protein production and function, and other phenotypic responses which are dependent on a toxicant, time and length of exposure, the organism, and the like. One goal of toxicogenomics research is the elucidation of the sequence of events leading to a biological response to a toxic stimulus. Currently available bioinformatics tools prove inadequate in elucidating such biological pathways. Moreover, current bioinformatics tools prove inadequate in presenting information in such a format as to allow prediction of biological responses to stimuli.

The invention addresses the need described above in the art of bioinformatics tools by providing a knowledge base suitable for meaningful analysis of biological information. These and other advantages of the invention, as well as additional inventive features, will be apparent from the description of the invention provided herein.

### BRIEF SUMMARY OF THE INVENTION

In a preferred embodiment, the invention provides a method to develop a system of predictive toxicology in the form of a multigenome (multispecies) knowledge base incorporating, for example, gene and amino acid sequences, molecular expression data, gene/protein functional annotation, domain specific ontologies, and/or literature mapping. By definition, a knowledge base uses data and information to carry out tasks and create new information. The present invention is neither a database nor a repetitive device or process, but rather a dynamic concept for integrating large volumes of seemingly disparate knowledge, such as genomic, proteomic, and/or toxicological knowledge in a framework that serves as a continually changing heuristic engine for predictive toxicology.

The invention allows characterization of the effects of, for example, chemicals or stressors across species as a function of dose, time, and phenotype severity. In addition, the invention is useful for classifying toxicological effects and disease phenotype, as well as delineating biomarkers, sequences of key molecular events responsible for biological response, and mechanisms of action of a stressor on a biological system.

A unique attribute of this knowledge base is that it can be globally queried by means of local sequence alignment as well as by any other knowledge base object, e.g., chemical structure, histopathology, clinical chemistry, phenotypic observations, SNPs, haplotypes, etc. This is because every data type or object in the knowledge base has a sequence attribute, i.e., every data type is linked to nucleic acid sequences, corresponding amino acid sequences, as well as associated literature citations that have been “sequence-tagged.” This sequence linkage enables continuous refinement of data quality, information documentation, and integration of new knowledge across species (for example, as new genes and proteins are identified and sequenced).

Any molecular expression profile derived experimentally or clinically, represented by DNA, RNA, proteins or peptides, or partial nucleic acid or amino acid sequences known to the knowledge base, can be used to globally query the knowledge base to find common concordant expression profiles reflecting specific clinical observations and measurements that have been indexed and context documented in terms of dose, treatment time and phenotypic severity. As a consequence of this design, reverse query of phenotypic severity attributes (e.g., specific histopathology) can provide entree into molecular expression profiles and associated sequelae. Molecular expression profiles that match a query dataset of nucleic acid or amino acid sequence can be presented in rank order by quality of match for all significant matches, together with all associated experimental data. In situations involving proprietary chemicals or drugs, a sequence-based (e.g., a DNA, RNA, or amino acid sequence-based) query can be performed without divulging the name or chemical structure.

Because the knowledge base contains data from multiple species of organisms, as the understanding of genetic and biochemical pathways builds toward congruence over time, the sequence-based system facilitates more precise definition of biological pathways as well as genetic variability and susceptibility to, for example, environmental, chemical, or biological insult among species. The ability of the knowledge base to predict toxicological outcomes increases as the volume of information entered into the system grows with time.

### BRIEF DESCRIPTION OF THE DRAWINGS

While the appended claims set forth the features of the present invention with particularity, the invention, together with its advantages, may be best understood from the following detailed description taken in conjunction with the accompanying drawings of which:

FIG. 1 is a schematic diagram of an exemplary computer architecture on which the mechanisms of the invention may be implemented;

FIG. 2 is a block diagram showing exemplary experimental datasets input into the knowledge base;

FIG. 3 is a block diagram showing exemplary sources of annotation and literature data input into the knowledge base;

FIG. 4 is a process flow diagram illustrating an automatic genomic sequence alignment process;

FIG. 5 is a data flow diagram showing a functional characterization process for gene and protein groups;

FIG. 6 is a data flow diagram showing a sequence based query of the knowledge base; and

FIG. 7 is a process flow diagram showing an expression profile matching process.

### DETAILED DESCRIPTION OF THE INVENTION

In the description that follows, the invention is described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that several of the acts and operations described hereinafter may also be implemented in hardware.

Turning to the drawings, wherein like reference numerals refer to like elements, the invention is illustrated as being implemented in a suitable computing environment. The following description is based on illustrated embodiments of the invention and should not be taken as limiting the invention with regard to alternative embodiments that are not explicitly described herein.

### I. Exemplary Environment

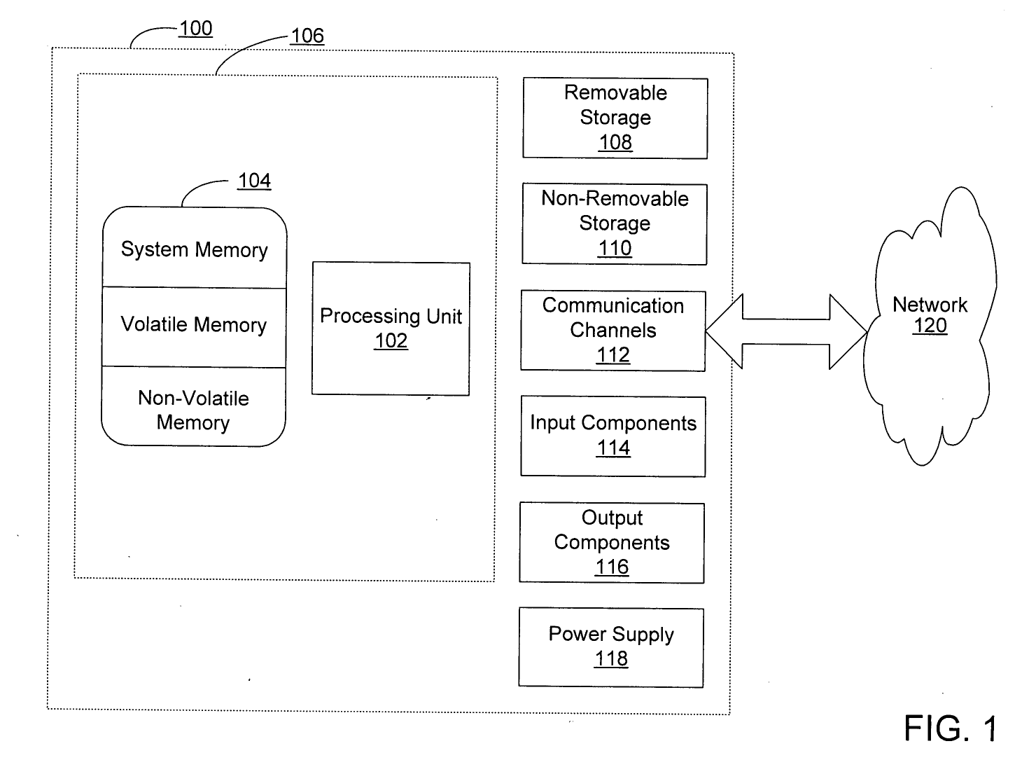

Referring to FIG. 1, the present invention relates to the development and querying of a sequence driven contextual knowledge base. The knowledge base resides on a computer that may have one of many different computer architectures. For descriptive purposes, FIG. 1 shows a schematic diagram of an exemplary computer architecture usable for these devices. The architecture portrayed is only one example of a suitable environment and is not intended to suggest any limitation as to the scope of use or functionality of the invention. Neither should the computing devices be interpreted as having any dependency or requirement relating to any one or combination of components illustrated in FIG. 1. The invention is operational with numerous other general-purpose or special-purpose computing or communications environments or configurations. Examples of well known computing systems, environments, and configurations suitable for use with the invention include, but are not limited to, mobile telephones, pocket computers, personal computers, servers, multiprocessor systems, microprocessor-based systems, minicomputers, mainframe computers, and distributed computing environments that include any of the above systems or devices.

In its most basic configuration, a computing device 100 typically includes at least one processing unit 102 and memory 104. The memory 104 may be volatile (such as RAM), non-volatile (such as ROM and flash memory), or some combination of the two. This most basic configuration is illustrated in FIG. 1 by the dashed line 106.

Computing device 100 can also contain storage media devices 108 and 110 that may have additional features and functionality. For example, they may include additional storage (removable and non-removable) including, but not limited to, PCMCIA cards, magnetic and optical disks, and magnetic tape. Such additional storage is illustrated in FIG. 1 by removable storage 108 and non-removable storage 110. Computer-storage media include volatile and non-volatile, removable and non-removable media implemented in any method or technology for storage of information such as computer-readable instructions, data structures, program modules, or other data. Memory 104, removable storage 108, and non-removable storage 110 are all examples of computer-storage media. Computer-storage media include, but are not limited to, RAM, ROM, EEPROM, flash memory, other memory technology, CD-ROM, digital versatile disks, other optical storage, magnetic cassettes, magnetic tape, magnetic disk storage, other magnetic storage devices, and any other media that can be used to store the desired information and that can be accessed by the computing device.

Computing device 100 can also contain communication channels 112 that allow it to communicate with other devices. Communication channels 112 are examples of communications media. Communications media typically embody computer-readable instructions, data structures, program modules, or other data in a modulated data signal such as a carrier wave or other transport mechanism and include any information-delivery media. The term “modulated data signal” means a signal that has one or more of its characteristics set or changed in such a manner as to encode information in the signal. By way of example, and not limitation, communications media include wired media, such as wired networks and direct-wired connections, and wireless media such as acoustic, radio, infrared, and other wireless media. The term computer-readable media as used herein includes both storage media and communications media. The computing device 100 may also have input components 114 such as a keyboard, mouse, pen, a voice-input component, and a touch-input device. Output components 116 include screen displays, speakers, printers, and rendering modules (often called “adapters”) for driving them. The computing device 100 has a power supply 118. All these components are well known in the art and need not be discussed at length here.

### II. The Sequence Driven Contextual Knowledge Base

The present invention is directed to the development and querying of a sequence driven contextual knowledge base. This knowledge base can be used to predict toxicological outcomes and facilitate a more precise definition of pathways as well as genetic variability and susceptibility among species to chemical, biological, or environmental stimuli. The methods of development and querying of a sequence driven contextual knowledge base disclosed in this application may exist as a computer-readable medium having stored thereon computer-executable instructions for performing the methods.

To gain an understanding of the need for such a knowledge base it helps to consider the study of toxicogenomics. Toxicogenomics is a new scientific field that studies an organism's response on the genomic level to environmental stressors or toxicants. For example, exposure to a drug or chemical can induce up-regulation of some genes and down-regulation of others, potentially changing the protein profile produced by a cell. The pattern of gene expression is likely different in response to exposure to different chemicals, creating a characteristic pattern or “signature”. A signature pattern of gene expression provides a means of predicting in vivo responses to poorly characterized chemicals. Likewise, signature patterns of expression or adverse events to chemical, biological, or environmental insult can elucidate biomarkers, which signal a particular molecular or phenotypic event.

Toxicogenomics seeks to use signature gene expression patterns to generate new predictors of toxicological responses using DNA microarray analysis and proteomics as alternatives to traditional toxicological predictors, such as physical examinations, tissue samples, and blood tests. An understanding of mechanisms of toxicity and disease will improve as these new methods are used more extensively and toxicogenomics databases are developed more fully. The result will be the emergence of toxicology as an information science that will enable thorough analysis, iterative modeling, and discovery across biological species and chemical classes.

With this goal in mind, in a preferred embodiment the present invention aims to develop a system of predictive toxicology in the form of a multigenome knowledge base incorporating, for example, nucleic acid sequence, amino acid sequence, molecular expression analysis, gene/protein functional annotation, domain specific ontologies, and/or literature mapping (Michael Waters et al., “Systems Toxicology and the Chemical Effects in Biological Systems (CEBS) Knowledge Base,” EHP Toxicogenomics 111(17), 15-28 (January 2003), and republished in Environmental Health Perspectives, 111(6), 811-824 (May 2003), which is herein incorporated in its entirety). By definition, a knowledge base uses data and information to carry out tasks and to create new information and here to provide a dynamic concept for integrating large volumes of seemingly disparate knowledge, such as genomic, proteomic, and toxicological knowledge in a framework that serves as a continually changing heuristic engine for predictive toxicology.

While the focus is on molecular expression analysis for toxicogenomics, one of ordinary skill in the art will appreciate that the concepts contained in this application have broad relevance in scientific investigation involving global research technologies such as transcriptomics and proteomics applied to diagnostic medicine, therapeutics and risk assessment and accelerated interpretation through searching the biomedical literature.

NCBI's GenBank is a major international resource for genomic (genome sequence) data. NLM's MEDLINE is a major international resource for accessing the published biomedical literature. Molecular expression analysis (e.g., for genes by microarray analysis or for proteins by 2-D polyacrylamide gel electrophoresis (PAGE) or other techniques) permits study of perturbations caused by drugs or environmental toxicants on potentially thousands of genes. However it has been found that neither GenBank nor MEDLINE supports direct global query using “signature” sequence information from molecular expression datasets or other phenotypic experimental or clinical observations.

A unique attribute of this knowledge base is that it can be globally queried by means of local sequence alignment as well as by any other knowledge base object, e.g., chemical structure, histopathology, clinical chemistry, phenotypic observations, SNPs, haplotypes, etc. This is because every data type or object in the knowledge base will have a sequence attribute, i.e., every data type will be linked to nucleic acid sequence and amino acid sequence information, as well as associated literature citations that have been “sequence-tagged”.

Using bona fide synonym gene and protein names and other identifiers, sequence-tagging software will locate and tag genes and/or protein citations in the published literature for association with particular nucleic acid sequences, amino acid sequences, molecular expression datasets, and/or toxicological outcomes or phenotypes. The fact that all molecular expression datasets, related literature, ontologies, histo- and clinical pathology, biological pathways, etc., in the multigenome knowledge base will be sequence-tagged and can be queried by sequence alignment enables continuous refinement of data quality, information documentation, and integration of new knowledge across species (for example, as new genes and proteins are identified and sequenced).

Any molecular expression profile derived experimentally or clinically, representing expressed genes, proteins produced, or partial nucleic acid or amino acid sequences known to the knowledge base, can be used to globally query the knowledge base to find common concordant expression profiles reflecting specific clinical observations and measurements that have been indexed and context documented in terms of dose, treatment time and phenotypic severity. As a consequence of this design, reverse query of phenotypic severity attributes (e.g., specific histopathology, clinical chemistry parameters, clinical observation, and the like) can provide entree into molecular expression profiles and associated sequelae. In situations involving proprietary chemicals or drugs, this sequence-based query can be performed without divulging the name or chemical structure of proprietary agents. Molecular expression profiles that match a query dataset of gene or protein sequence can be presented in rank order by quality of match for all significant matches, together with all associated experimental phenotypic data.

Because the knowledge base will contain data from multiple species, as understanding of genetic and biochemical pathways builds toward congruence over time, the sequence-based system will facilitate a more precise definition of biological pathways as well as genetic variability and susceptibility among species for example, to chemical, biological, or environmental insult. The ability of the knowledge base to predict toxicological outcomes will increase as the volume of information entered into the system grows with time.

### III. Collection of Toxicological Experimental Datasets and Information

The inventive method is well suited for organizing biological raw data and correlating that information to elucidate relationships between biological processes. Accordingly, the data sets can comprise data obtained from any source including literature, databases, clinical observations, and generated from the study of biological processes, preferably biological processes associated with toxicology or pharmacology. For example, the data sets can comprise data related to nucleic acid sequences, amino acid sequences, pharmacology, toxicology, clinical chemistry, histopathology, one or more signal transduction, metabolic, pharmacological or toxicological pathways, gene expression, protein production, molecular interactions (e.g., protein-protein or protein-DNA interactions), chemical structure, metabolite synthesis, degradation or elimination, and/or clinical pathology.

Nucleic acid sequences are polymers of nucleotides and include deoxyribonucleic acid (DNA) and ribonucleic acid (RNA). Information regarding DNA or RNA can be obtained experimentally using, for example, automated sequencers. Nucleic acid information also can be obtained from genomic data repositories, which often take the form of internet-based databases such as the publicly available GenBank and European Molecular Biology Laboratory (EMBL) Nucleotide Sequence Database or commercially-available database systems which require subscription of a user for access to nucleic acid information. The genomic data repositories ideally contain annotated information regarding the nucleic acid sequences stored therein, including, but not limited to, promoters, 5′UTR, 3′UTR, splice sites, introns, exons, source organism, chromosomal location, encoded RNA and/or amino acid sequence, location within the host genome, and encoded function.

Pharmacology is the general study of the effect of chemical agents, e.g., drugs, on a biological system. Pharmacology studies often comprise a multi-disciplinary approach to identify biological targets of drug action, the mechanism by which a drug exerts its effect, and the therapeutic and toxic profiles of drugs. Pharmacology data can include, for example, the amount of chemical agent or chemical metabolite in the blood, chemical breakdown profile, toxicity profile, the rate at which the drug and its metabolites are excreted, bioavailability, as well as physiology data such as blood pressure, liver function, heart rate, and the like.

Toxicology data involve the measurement of unwanted effects of an environmental stressor or chemical or biological agent on a biological system. In other words, toxicology entails the analysis of fundamental biological processes and the mechanisms by which toxic agents adversely affect such biological processes. The toxic effects of specific chemicals can be characterized and quantified using routine laboratory methods. The data provided by the knowledge base can include, for example, measurements of toxicant byproducts in blood, breath, urine, and/or tissue samples. Toxicology data also can comprise observation or measurement of morphological changes of target tissues (e.g., fibrosis, apoptosis, tissue breakdown, hypertrophy, and the like). The data provided can be employed, for example, to determine the relationship between dose, administration, and duration of exposure of an organism to a potential toxicant.

By “clinical chemistry” is meant the use of chemical, molecular, and cellular techniques to quantify the effects of a toxicant on a biological system via the presence and amount of metabolites, byproducts, enzymes, electrolytes, metals, and the like in a biological sample (e.g., blood, urine, or tissue sample). For example, creatinine is associated with breakdown of muscle tissue and can be detected and quantified in a blood sample. Similarly, alterations of urea nitrogen or albumin concentrations in the blood can indicate kidney malfunction. Other targets for chemical analysis include, but are not limited to, alkaline phosphatase, bilirubin, calcium, chloride, cholesterol, creatine kinase, drug metabolites and byproducts, glucose, potassium, sodium, total protein, triglycerides, and uric acid.

The data set of the inventive method also can include histopathology data. Histopathology is the study of diseased or malfunctioning tissues at the cellular and molecular level and can comprise the sampling, staining, and microscopic observation of a tissue sample. Accordingly, histopathology data can include, for instance, the presence and extent of necrosis, inflammation, apoptosis, congestion, and/or mitosis in cells from tissue preparations of various organs. Cell proliferation and apoptosis assays are generally used in the art to detect changes in histopathology in response to chemical or environmental insult.

Signal transduction pathways activated or down-regulated in response to toxicant exposure can provide insight into potential targets for therapeutic intervention. Data regarding signal transduction pathways include information regarding the sequence of intracellular events which lead to a specific cellular process. For example, a cellular membrane receptor can be activated, which, in turn, activates kinases within the cellular environment ultimately leading to changes in gene expression. The interaction of proteins within a pathway or system often plays a role in functionality. Characterization of such protein-protein and protein-DNA interactions can yield critical information on mechanism of action. Prediction algorithms can be employed to analyze structural biochemistry data (X-ray crystallography, fluorescence spectroscopy) from the protein of interest.

The process of toxicant (or any chemical agent) metabolism in vivo (e.g., metabolic, pharmacological, and toxicological events associated with drug action) can be critical for proper compound screening and selection in drug development. Toxicants are metabolized by a number of different chemical pathways with catalysis by many different enzymatic systems. The absorption, distribution, metabolism and excretion profiles can allow understanding of a mechanism of action for the toxicant or drug. For example, microsomes (e.g., cytochrome P450 enzyme system) and hepatocytes play a major role in determining metabolic processes and pathways. Assays quantifying microsome and hepatocyte function provide data useful for a toxicology knowledge base.

In addition, it is useful to understand the effects of chemical, biological, or environmental insult on gene expression, i.e., whether expression of particular genes is up- or down-regulated in response to insult. Gene expression can be examined by serial analysis of gene expression (SAGE), EST sequencing, and microarray analysis, which is a method of visualizing the patterns of gene expression of thousands of genes simultaneously using, for example, fluorescence. Commercially available microarrays can be employed to generate raw biological data for inclusion into the knowledge base of the invention. Alternatively, microarrays can be constructed to determine signature patterns of exposure or signature patterns of adverse effects for a potential toxicant. For such a microarray, the nucleotide sequences of the probes adhered to the microarray substrate preferably are confirmed by two or more rounds of sequencing. For both commercially-available and custom-designed microarrays, the nucleotide sequences of the bound probes are included in the knowledge base and annotated with the full nucleotide sequence (e.g., available in GenBank and/or EMBL) and/or relevant literature.

Alternatively or in addition, data associated with the effect of toxicant exposure on protein production in a cell can be included in the knowledge base. Such data is useful in characterizing the overall response of a biological system to environmental, chemical, or biological insult. Two-dimensional polyacrylamide gel electrophoresis (2D-PAGE), Western Blots, and mass spectrometry are common laboratory methods for identifying and quantifying proteins.

The data sets also can comprise information regarding the potential toxicant (e.g., the environmental, chemical, or biological agent) or its metabolites. Ideally, the name of the potential toxicant, metabolites, and synonyms thereof are provided by the knowledge base. If appropriate, the chemical formula, CAS number, and chemical structure can be provided. Chemical structure provides a reference for comparing two or more toxicants and can be useful in predicting the outcome of traditional toxicology assays. Chemical structure can be determined using spectroscopy, X-ray crystallography, and/or NMR. In addition, known uses of a potential toxicant can be provided.

In evaluating the gross phenotypic changes associated with toxicity, clinical pathologists study the progression of disease, how the disease manifests, the effects of internal and external derangements on certain cells and tissues, and develop methods for monitoring disease progression. Data associated with clinical pathology is generated from, for example, blood analysis and tissue preparations.

The information obtained by the inventive method is provided “in context,” meaning that the toxicogenomic information provided is annotated with the parameters used to generate the data. Accordingly, the protocol designs for generating data are preferably sequence-tagged with the resulting data. Protocol design parameters include the agent administered, the route of administration, the length of the study, the measurements taken (e.g., what assays are performed to determine the effect of the agent on the biological system), the species and strain of animal subjects, the number of animals in the study the frequency of measurements, methods of sample preparation, and the dose of the agent administered. In that context-driven data is presented to the user, a more accurate and complete understanding of toxicity is achieved.

### IV. Development and Querying of the Sequence Driven Contextual Knowledge Base

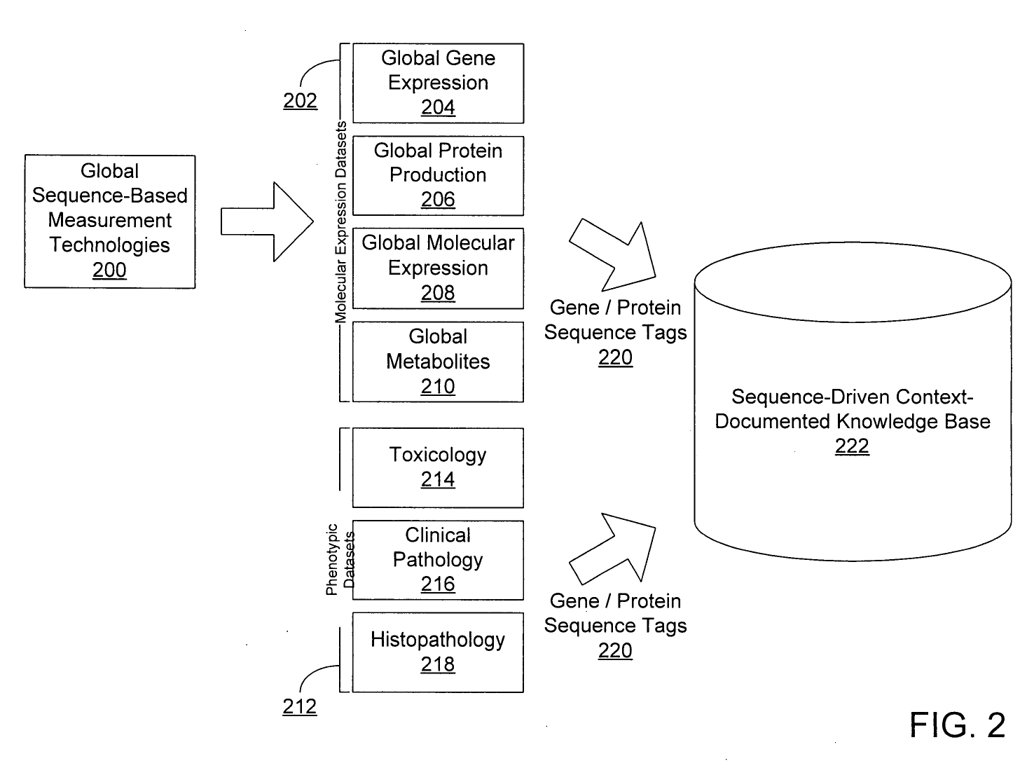

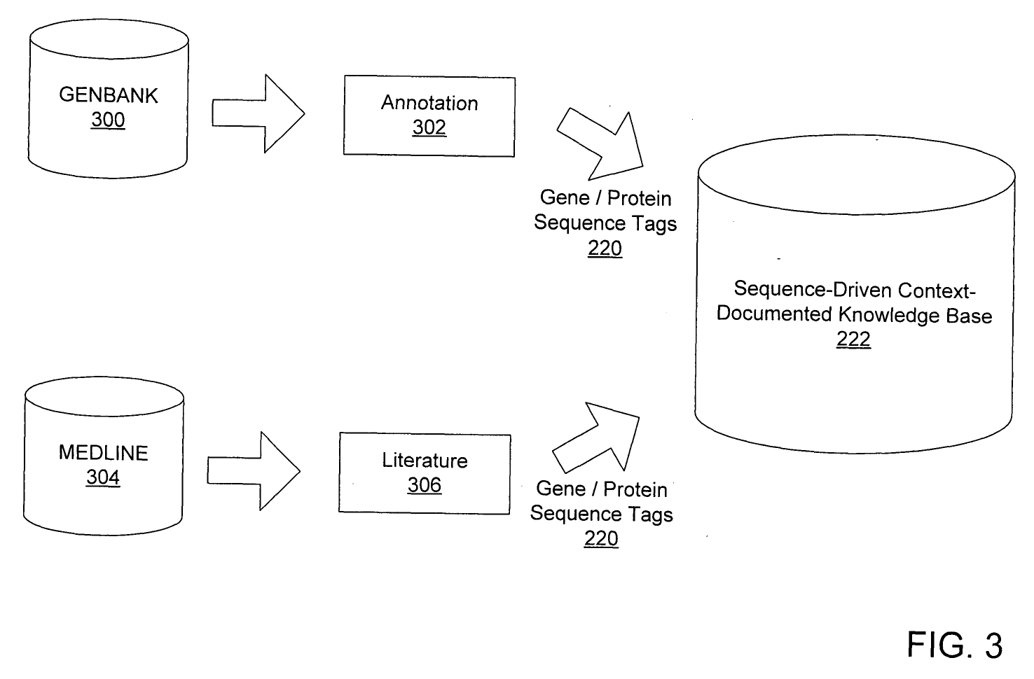

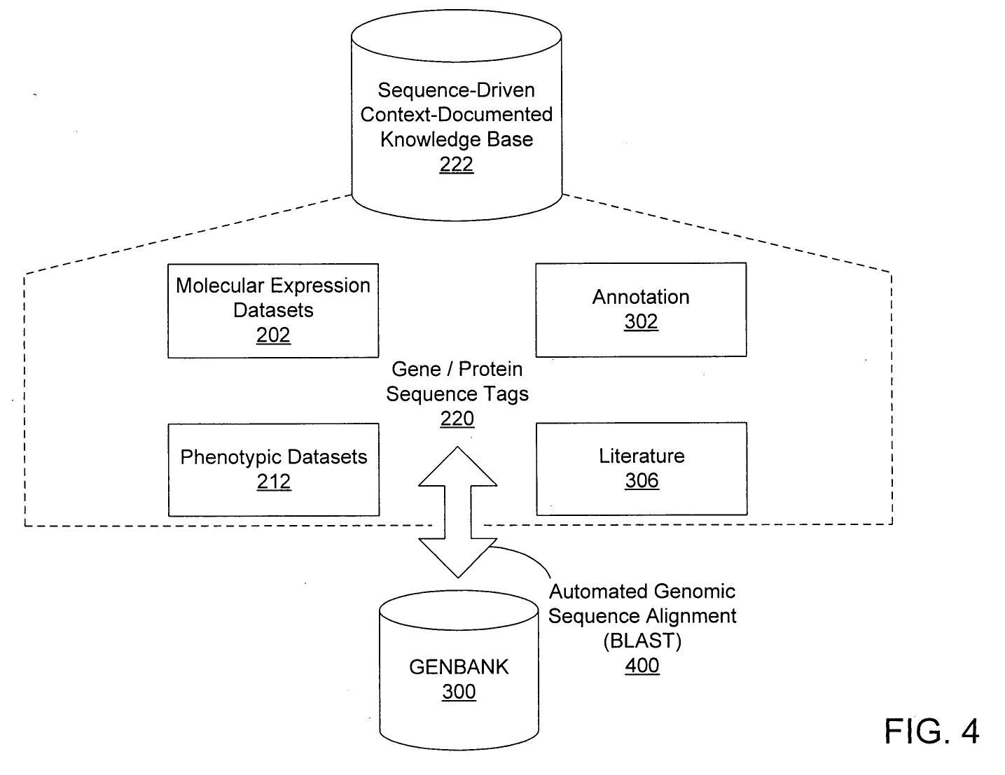

Turning to FIGS. 2, 3, and 4, as datasets 202, 212 are deposited in the knowledge base 222, the nucleic acid sequence 220 of the microarray probes 200, expressed sequence tags (ESTs), or oligonucleotides (preferably as well as all encoded proteins or peptides) are verified on a per microarray (or experiment) basis and linked to a database of bona fide target gene names and synonyms thereof for, preferably, at least one genome of interest.

The deposition of datasets 202, 212 into the knowledge base 222 is based on standardized microarrays 200, either custom-made or commercially-available. All oligonucleotide probes on the microarray 200 are sequence-verified (resequencing is preferred for all clone sets used for cDNA microarrays). This sequence information 220 is used to BLAST 400 GenBank 300 to determine that putative GenBank accession numbers and the oligonucleotide sequence data 220 for the probes correspond. Resequencing data is given preference if it is found to represent a different gene than originally identified by a clone set or GenBank accession number. EST identification is via sequence, however, the knowledge base maintains GenBank accession numbers (multiple archival IDs), dbEST cluster IDs, Gene Index consensus sequence, and may MegaBLAST the consensus sequence against Trace Archives to maintain current genomic sequence mapping to the extent possible.

The “sequence tag” 220 is the common currency within the knowledge base 222 and all such sequence tags 220 have defined sequence alignment to a known nucleic acid sequence. This is referred to as a “gene model” approach, i.e., identifying the probes represented on a chip 200 based on sequence alignment to known gene sequence. It should be noted that, other than for RefSeg genes, the nucleic acid sequence of a gene may not be fully defined, i.e., there may be characterized segments and uncharacterized segments (i.e. gaps) for known genes. The knowledge base 222 tracks each GenBank 300 update in order to maintain fidelity 400 with evolving gene identification and genomic sequence definition. Thus, the knowledge base 222 maintains current sequence alignment definition against a gene model for each probe on each microarray for each genome represented in the knowledge base 222.

All peptides or proteins identified by 2D-PAGE and mass spectrometry or other means of peptide separation 200 are similarly cataloged on a per experiment or per microarray 200 basis per model gene basis (i.e., each identified protein is referenced to the same gene model as the gene probe on the microarray). In this way, should an oligonucleotide probe-to-gene relationship change there is a flag to check the peptide or protein-to gene-relationship for the putative corresponding protein(s). The knowledge base 222 tracks the evolving proteomes through GenBank 300 and other public protein database updates (i.e., it tracks several proteome public resources).

A database of bona fide gene names and synonyms thereof for microarrays 200 and genomes of interest is developed to facilitate query of the published literature 306. With full or partial sequence definition 220 of all genes and proteins in the knowledge base 222, it becomes possible to BLAST or sequence-align 400 outlier genes and proteins from new experimental datasets 202, 212 against all corresponding datasets contained in the knowledge database 222. Using the example of a toxicogenomics knowledge base, this facilitates and informs the integration of transcriptomics and proteomics datasets (gene expression and protein production) across treatment, dose, time, tissue type, and phenotypic severity for multiple test-compound datasets. Importantly, the knowledge base 222 becomes independent of measurement technology 200 and molecular expression platform. The fidelity of the knowledge base's ability to interpret datasets improves with the convergence of knowledge of sequence.

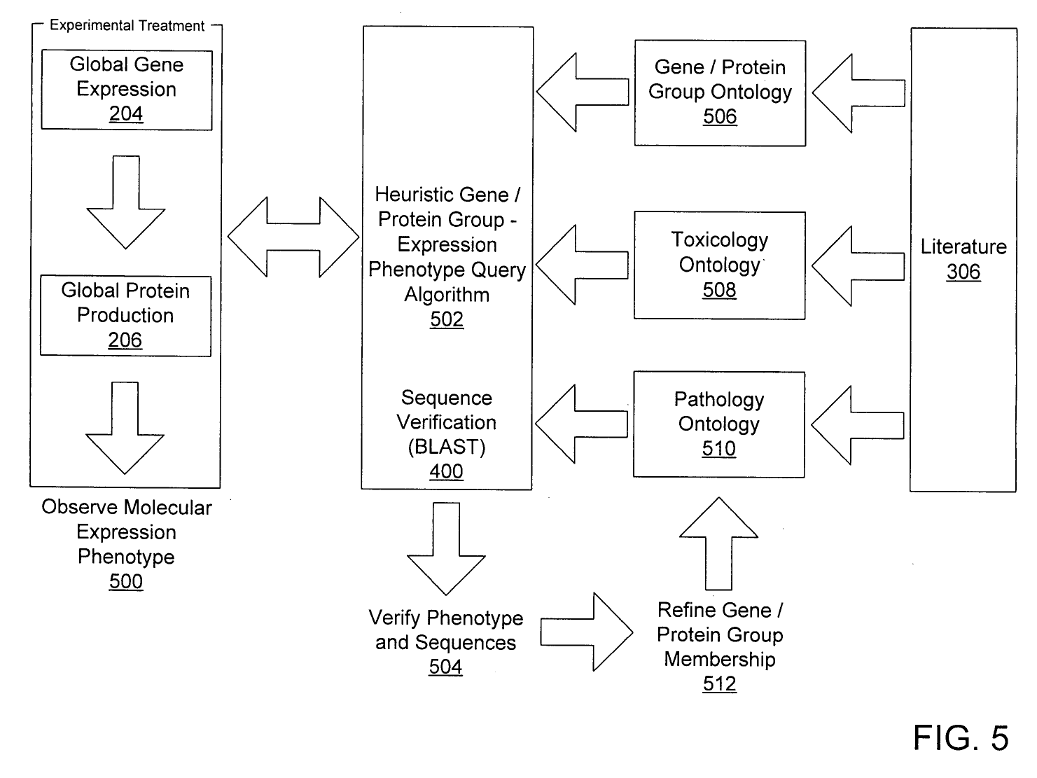

With reference to FIG. 5, the published scientific literature 306 is queried using a proximity-of-data query (e.g., InPharmix PDQ_MED software) with the important addition of sequence tagging of genes and proteins identified in MEDLINE abstracts. Sequence tagging 400 of each gene or protein cited in an abstract facilitates “mapping” and global search of the published literature for each gene or protein in a gene/protein query set. This documents the evaluation and interpretive process in molecular expression analysis. The scientific literature can be used to classify genes into putative functional gene groups 512 and apply global molecular expression techniques to confirm and iteratively optimize functional gene group membership 512.

As mentioned above, common (literature-searchable) gene names are ideally derived for all clone and oligonucleotide sets and proteins represented in the knowledge base 222. Using a proximity-of data-query software tool (e.g., PDQ_MED) the MEDLINE and PubMed literature 306 can be mined for functionally important genes and proteins for a particular toxicant. As genes and proteins are identified in the literature 306, the gene or protein name (including all known synonyms) in the abstract is “sequence-tagged” 400. This is accomplished by essentially reversing the searching processes used to initially identify the genes and proteins in the abstract. The knowledge base then identifies the pertinent abstracts using the MEDLINE unique ID, MUID, or the PubMed ID so that the abstracts can be accessed in PubMed.

The knowledge base 222 uses the gene ontology 506 from the GO Consortium at http://www.geneontology.org, to guide the naming of gene groups and incorporates the GO ontology 506 in the annotation for each microarray (which effectively sequence-tags the GO ontology within the knowledge base). A similar approach can be followed with other ontologies 508, 510, and new versions of the ontologies can be accessed frequently. If necessary, the knowledge base 222 can define (based on literature) a toxicology ontology 508 (based on GO biological process, molecular function, or cellular component) for each gene in each clone or oligonucleotide set.

Appropriate functional groupings 512 that match other known controlled vocabularies and ontologies 506, 508, 510 (toxicology, clinical chemistry, pathology, etc.), especially as they may relate to known pathways, can be derived from the literature 306. Note that an ontology lists similar elements while a pathway describes an interaction among diverse elements. Putative gene groups can be assimilated in the appropriate ontologies and pathways using literature-based gene proximity analysis and other literature search and visualization software (such as OmniViz) to guide the process. The optimization process can involve ranking each gene in the literature group versus the experimental group. A heuristic statistical algorithm 502 can be developed to test putative functional gene/protein groups 512 (derived from the literature 306) against treatment-related molecular expression profiles 204, 206 (and against co-regulated clustered genes and expressed sequence tags) to confirm gene/protein grouping based on molecular expression phenotype 500, 504. In other words, the correlation of putative gene group versus expression phenotypes is tested 504 and modified to heuristically refine gene group membership 512 based on phenotype (e.g., optimize gene group membership by eliminating a gene at a time and retesting). The optimization process will involve ranking each gene in the literature group versus the experimental group. Such a comparative group analysis can be performed using, for example, a Bayesian network model followed by leave-one-gene-out cross validation.

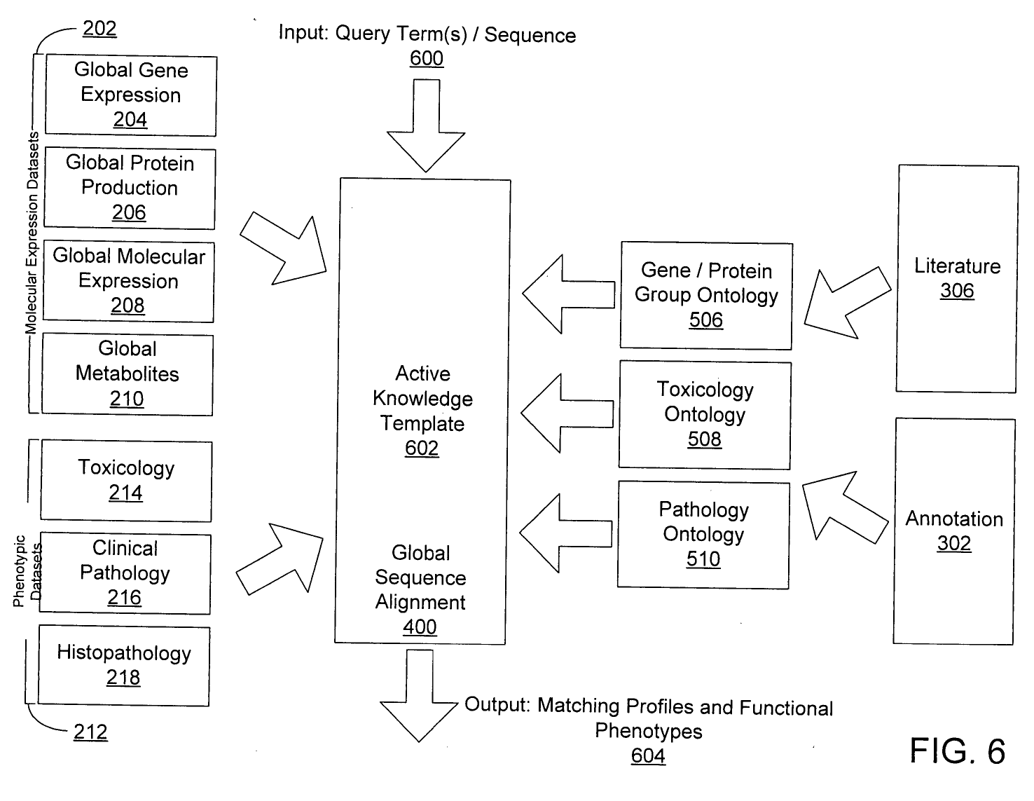

Turning to FIG. 6, the knowledge base 222 creates an Active Knowledge Template 602 for the molecular expression domains of interest 202 (e.g., transcriptomics, proteomics, metabonomics) combining the experimental elements (or objects) of these domains and detailing how experimental data is captured in the knowledge base 222.

The Active Knowledge Template 602 includes all genes and proteins and their sequences that have been included in the knowledge base 222. The Active Knowledge Template 602 continuously accesses and retrieves from public resources updated annotation 302 for all genes and proteins (based on their sequences) that have been included in the knowledge base 222. The annotation of genes and proteins is actively updated on a per experiment and per microarray basis via the use of an automated Distributed Annotation System (DAS) server that, on demand, visits identified public annotation information resources, collects requisite annotation 302 (in XML format) and deposits it in the knowledge base 222. The relative quality and completeness of the annotation 302 of each gene/protein may be calculated using a scoring system so as to classify the quality of the annotation dataset 302 for any particular gene or protein. There may be other information gathering tools, such as Web crawlers and literature search,tools that contribute actively to the evolution of the Active Knowledge Template 602.

The knowledge base 222 uses carefully documented experimental protocols to define, for example, the doses and the time course as well as the bioassays and biological measurements and various conditions for datasets to be included in the knowledge base 222. The knowledge base 222 classifies statistically significant outlier genes on a functional basis following drug or chemical treatment, fully documenting the context of altered gene expression (i.e., treatment, dose, time, tissue, phenotype). A bioinformatics protocol specifies the various statistical and clustering algorithms that are applied to determine correlated and co-regulated genes. Using literature-derived putative gene groups (vetted in appropriate gene ontologies 506, 508, 510), an iterative and heuristic gene/protein group phenotype analysis 502 is performed as described above. The knowledge base 222 continually tests (query) assigned functional gene groups against nascent treatment-related expression profiles to confirm gene grouping based on phenotype 504. Such an analysis yields validated gene/protein groups that map to known functional pathways. The knowledge base 222 analyzes gene expression context information (dose, time, tissue, phenotype) relationships to investigate ontology and gene group classification, including potential pathway and network involvement. The knowledge base predicts expressed protein sequences based on in silico translation of genes and confirms putative functional attributes of protein products. The knowledge base 222 retrieves protein expression data in experimental context 604 and queries it using refined in silico translated protein phenotypic groups as described previously for gene groups. Over time, compendia of data are assembled within each toxicogenomic (e.g., transcriptomics, proteomics, metabonomics) and toxicological/pathological domain. In terms of toxicology, such analyses defines the sequence of key events and common modes-of-action for environmental chemicals and drugs.

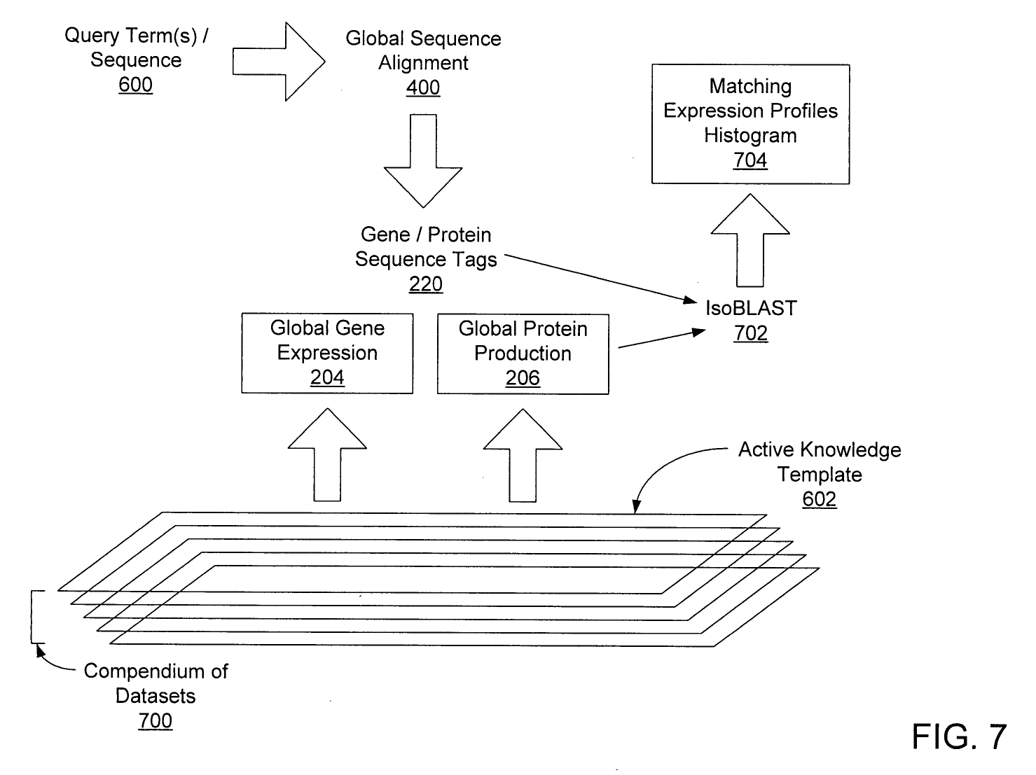

With reference to FIG. 7, the knowledge base 222 is populated with multiple data compendia 700 representing, for example, compounds tested under various conditions of dose and time using molecular expression analysis and conventional methods of toxicology and pathology. Using simple BLAST technology 400, wherein a sequence-verified query transcriptome (or list of outliers) or proteins of known sequence is aligned with like sequences in the knowledge base 222, information is recovered on analogous data compendia (or sub-elements of compendia) 700.

IsoBLAST 702 identifies common sequence-aligned genes 220, expressed sequence tags 204, and proteins 206 throughout the knowledge base 222, which are presented in the full context of the data compendia (e.g., in the case of toxicogenomics, as a function of dose, time and toxicologic or pathologic phenotypic severity). One example of data output is a topographic map representing the content of the knowledge base by gene and protein expression, organized according to the Active Knowledge Template 602 into gene groups, known pathways, networks, etc. as defined by knowledge that is actively updated. If expression profiles associated with chemical or drug treatments are sought, the knowledge base 222 performs a restricted query to find sequence-matched molecular expression profiles for chemicals or drugs. The best matching molecular expression profile is returned based on common concordant gene or protein expression data (i.e., when there is an alignment of sequence between query genes/proteins and knowledge base genes/proteins).

Common genes or proteins from the data compendia (e.g., on a compound basis) are collected within the knowledge base and it is determined whether they are concordant with the query transcriptome (or list of outliers or proteins). The probability that a concordant or matching pattern of expression could have occurred by chance can be calculated from the binomial distribution.

The knowledge base sequence matches a partial query transcriptome to the best matching compound in the knowledge base using IsoBLAST 702 to find common concordant sequences. As an example of one representation of retrieved data, a histogram 704 can be plotted, illustrating outlier up-regulated and down-regulated genes as a function of relative expression levels. Such histogram plots 704 based on data sets recovered by IsoBLAST 702 are by virtue of context definition “phenotypically-anchored” in tissue/dose/time/phenotypic severity. As an illustrative example the phenotypic severity of necrosis and apoptosis that was encountered in rat liver following exposure to acetaminophen under known conditions of dose and time may correspond to the molecular expression data in the best matching expression profile. Thresholds can be established to permit display of matching expression profiles of varying degrees of quality as they are recovered by BLASTing the knowledge base 222. Matching expression profiles of predefined quality can then be listed in a best-match to poorest-match sequential list (Waters et al., “Genetic activity profiles and pattern recognition in test battery selection,” Mutation Research, 205, 119-138, which is herein incorporated in its entirety). Assuming the expression data is absolute or quantitative (as will be possible to determine globally) it is also possible to measure the quantitative agreement of common concordant expression datasets. This can then begin the process of developing toxicogenomic physiologically-based toxicokinetic models.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of querying and receiving information, wherein the method comprises
(a) providing to a query engine a query term;
(b) matching a nucleic acid sequence tag to the query term;
(c) identifying at least one active knowledge template comprising the information described in context and related by the nucleic acid sequence tag; and
(d) returning the information from the active knowledge template.

2. The method of claim 1, wherein the information comprises toxicogenomic information.

3. The method of claim 1, wherein the query term comprises one or more nucleic acid sequences.

4. The method of claim 1, wherein the query term comprises one or more amino acid sequences.

5. The method of claim 1, wherein the active knowledge template comprises data sets for molecular expression assays, experimental protocols for which a biological sample is generated for the molecular expression assays, and phenotypic outcomes resulting from the experimental protocols.

6. The method of claim 5, wherein the active knowledge template comprises data sets for literature pertaining to the data sets.

7. The method of claim 6, wherein the data sets comprise data related to nucleic acid sequences, pharmacology, toxicology, clinical chemistry, histopathology, one or more signal transduction, metabolic, pharmacological or toxicological pathways, gene expression, protein production, molecular interaction (protein-protein or protein-DNA), chemical structure, metabolite synthesis, degradation or elimination, and/or clinical pathology.

8. A computer-readable medium having stored thereon computer-executable instructions for performing the method of claim 1.

9. A method of defining active knowledge templates, wherein the method comprises:
(a) accepting a first set of data;
(b) storing the first set of data;
(c) establishing relationships between the data and one or more nucleic acid sequence tags;
(d) accepting a second set of data; and
(e) modifying relationships between the first data set, the second data set and/or contextual information based on the accepted second data set.

10. The method of claim 9, wherein (d) and (e) are repeated at least once.

11. The method of claim 9, wherein the molecular expression data comprises toxicogenomic data.

12. The method of claim 9, wherein the contextual information comprises data sets for molecular expression assays, experimental protocols for which a biological sample is generated for the molecular expression assays, and phenotypic outcomes resulting from the experimental protocols.

13. The method of claim 12, wherein the active knowledge template comprises data sets for literature pertaining to the data sets.

14. The method of claim 13, wherein the data sets comprise data related to nucleic acid sequences, pharmacology, toxicology, chemical structures, clincal chemistry, histopathology, one or more signal transduction, metabolic, pharmacological or toxicological pathways, gene expression, protein production, molecular interaction (protein-protein or protein-DNA), metabolite synthesis, degradation or elimination, and/or clinical pathology.

15. The method of claim 9, wherein the first data set comprises gene expression data determined by exposure of a microarray comprising oligonucleotide probes or cDNA probes of known sequence to a biological sample, wherein the oligonucleotide probes or cDNA probes are sequence verified and bind to predetermined gene products to produce a detectable signal.

16. The method of claim 15, wherein (c) comprises querying one or more genomic data repositories with a nucleotide sequence of one or more oligonucleotide probes to identify one or more genes corresponding to the one or more oligonucleotide probes via sequence alignment.

17. The method of claim 16, wherein (d) comprises searching literature databases for and nucleic acid sequence tagging scientific literature related to one or more identified genes or one or more products of the identified gene.

18. The method of claim 16, wherein one or more identified genes or one or more products of the identified genes are classified into putative functional groupings.

19. The method of claim 18, wherein one or more identified genes are grouped into signal transduction, metabolic, pharmacological, or toxicological pathways, or histopathological processes.

20. A computer-readable medium having stored thereon computer-executable instructions for performing the method of claim 9.
